(19) United States
(12) Patent Application Publication
(10) Pub. No.: US 2012/0221682 A1
(43) Pub. Date: Aug. 30, 2012

(54) REMOTE MOBILE COMMUNICATION SYSTEM AND REMOTE MOBILE COMMUNICATION METHOD

(75) Inventor: Kazunori Ozawa, Tokyo (JP)

(73) Assignee: NEC CORPORATION, Tokyo (JP)

(21) Appl. No.: 13/505,104

(22) PCT Filed: Oct. 26, 2010
(86) PCT No.: PCT/JP2010/068968

§ 371 Date: Apr. 30, 2012

(30) Foreign Application Priority Data
Oct. 28, 2009 (JP) 2009-247298
Oct. 28, 2009 (JP) 2009-247299

(51) Int. Cl. G06F 15/16

(52) U.S. Cl. 709/217

(57) ABSTRACT

A remote mobile communication system includes: a server device that includes a virtual client unit that receives instruction information from a mobile terminal via a mobile network and, based on the instruction information, generates screen information for causing an application to perform a screen display, and an encoder unit that compression-encodes the screen information, in part or in whole, and transmits the compression-encoded screen information to the mobile network; and a mobile terminal that receives the compression-encoded screen information via the mobile network and decompresses the screen information for display.

### TECHNICAL FIELD

### REFERENCE TO RELATED APPLICATION

The present application is based upon and claims the benefits of the priority of Japanese patent application No. 2009-247299 filed on Oct. 28, 2009 and Japanese patent application No. 2009-247298 filed on Oct. 28, 2009, the disclosure of which is incorporated herein in its entirety by reference thereto.

The present invention relates to a remote mobile communication system, a method, and a program, and more particularly to a remote mobile communication system, a method, and a program in which a mobile terminal remotely accesses a server device via a mobile packet network for performing operation while communicating with a virtual client on the server device.

### BACKGROUND ART

With the increase in speed and capacity of a mobile network realized by the LTE(Long Term Evolution) or EPC(Evolution Packet Core) technology, web access and content distribution services, including video (still image, moving image, etc.) and audio, will become more popular.

Patent Document 1 describes a mobile terminal that allows the user to easily obtain the additional information on a commercial product included in image information, which is received from an image distribution server, without contacting the information distribution source.

### PRIOR ART DOCUMENT

### Patent Document

### Patent Document 1:

Japanese Patent Kokai Publication No. JP-P2002-369180A

### SUMMARY OF THE INVENTION

### Problems to be Solved by the Invention

However, when an operator introduces a new service, the new service cannot sometimes be supported by an existing mobile terminal operating under the conventional service. In such a case, the problem is that, each time a new service is introduced, the user must purchase a new mobile terminal that supports the new service.

In addition, mobile terminals differ in ability, such as the codec format, bit rate, and resolution, according to the device type. When the codec format, bit rate, and screen resolution differ between a mobile terminal and a server, the problem is that the mobile terminal can neither display nor decode images.

In addition, the bandwidth of a mobile packet network or a mobile LTE/EPC network may vary depending upon the distance or the traffic amount between a base station and a mobile device. When information is transmitted from a server with no consideration for variations in the bandwidth, a packet loss may occur in the mobile network. This packet loss causes the server to retransmit the packet in the bearer mode, resulting in the problem that a long time is required for the mobile terminal to receive the information, the screen update is delayed and, therefore, the Quality of Experience (QoE) is degraded.

Furthermore, when downloading a file for viewing content such as a still image or a moving image, a mobile terminal must have a memory and storage means to temporarily store the downloaded file. The problem here is that, when the mobile network gets faster to allow a large-capacity file to be downloaded therefrom, the memory and the storage means of a mobile terminal must have a larger capacity.

Therefore, the problem is to eliminate the need for the user to purchase a new mobile terminal even when the operator introduces a new service. It is an object of the present invention to provide a remote mobile communication system, method, and program for solving the problems described above.

### Means to Solve the Problems

According to a first aspect of the present invention, there is provided a remote mobile communication system, comprising:
a server device that comprises:
a virtual client unit that receives instruction information from a mobile terminal via a mobile network and, based on the instruction information, generates screen information for causing an application to perform a screen display; and an encoder unit that compression-encodes the screen information, in part or in whole, and transmits the compression-encoded screen information to the mobile network; and
a mobile terminal that receives the compression-encoded screen information via the mobile network and decompresses the screen information for display.

According to a second aspect of the present invention, there is provided a server device comprising:
a virtual client unit that receives instruction information from a mobile terminal via a mobile network and, based on the instruction information, generates screen information for causing an application to perform a screen display; and
an encoder unit that compression-encodes the screen information, in part or in whole, and transmits the compression-encoded screen information to the mobile network.

According to a third aspect of the present invention, there is provided a remote mobile communication method comprising:

by a server device, receiving instruction information from a mobile terminal via a mobile network and, based on the instruction information, generating screen information for causing an application to perform a screen display; and
compression-encoding the screen information, in part or in whole, and transmitting the compression-encoded screen information to the mobile network.

According to a fourth aspect of the present invention, there is provided a program causing a computer to execute:
receiving instruction information from a mobile terminal via a mobile network and, based on the instruction information, generating screen information for causing an application to perform a screen display; and
compression-encoding the screen information, in part or in whole, and transmitting the compression-encoded screen information to the mobile network.

### Effects of the Invention

The remote mobile communication system, the method, and the program of the present invention eliminate the need for the user to purchase a new mobile terminal even when an operator introduces a new service.

### BRIEF DESCRIPTION OF THE DRAWINGS

FIG. 1 is a block diagram showing a configuration of a remote mobile communication system in a first exemplary embodiment of the present invention.

FIG. 2 is a block diagram showing a configuration of a server device in the remote mobile communication system in the first exemplary embodiment of the present invention.

FIG. 3 is a block diagram showing a configuration of a virtual client unit of the server device in the remote mobile communication system in the first exemplary embodiment of the present invention.

FIG. 4 is a block diagram showing a configuration of a server device in a remote mobile communication system in a second exemplary embodiment of the present invention.

FIG. 5 is a block diagram showing a configuration of a remote mobile communication system in a third exemplary embodiment of the present invention.

FIG. 6 is a block diagram showing a configuration of a remote mobile communication system in a fourth exemplary embodiment of the present invention.

FIG. 7 is a block diagram showing a configuration of a server device in the remote mobile communication system in the fourth exemplary embodiment of the present invention.

FIG. 8 is a block diagram showing a configuration of a virtual client unit of the server device in the remote mobile communication system in the fourth exemplary embodiment of the present invention.

FIG. 9 is a block diagram showing a configuration of a server device in a remote mobile communication system in a fifth exemplary embodiment of the present invention.

FIG. 10 is a block diagram showing a configuration of a remote mobile communication system in a sixth exemplary embodiment of the present invention.

### MODES FOR CARRYING OUT THE INVENTION

Preferably, a remote mobile communication system in a first mode is the remote mobile communication system in the first aspect described above.

Preferably, in the remote mobile communication system in a second mode, the server device further comprises a control unit that collects device type information from the mobile terminal, obtains an ability of the mobile terminal from the device type information and an ability table, and controls at least one of an encode format, bit rate, and screen resolution of the encoder unit to suit the obtained ability.

Preferably, in the remote mobile communication system in a third mode, the mobile terminal temporarily stores information, such as content, using a cache memory or a storage device provided in the server device.

Preferably, in the remote mobile communication system in a fourth mode, the mobile network is a mobile packet network or a mobile LTE/EPC network.

Preferably, a server device in a fifth mode is the server device in the second aspect described above.

Preferably, the server device in a sixth mode further comprises a control unit that collects device type information from a mobile terminal, obtains an ability of the mobile terminal from the device type information and an ability table, and controls at least one of an encode format, bit rate, and screen resolution of the encoder unit to suit the obtained ability.

Preferably, the server device in a seventh mode further comprises a cache memory or a storage device that temporarily stores information such as content.

Preferably, a remote mobile communication method in an eighth mode is the remote mobile communication method in the third aspect described above.

Preferably, a program in a ninth mode is the program in the fourth aspect described above.

According to a tenth mode, there is provided the remote mobile communication system wherein the encoder unit acquires downlink bearer QoS(Quality of Service) information, which is set by a packet forwarding device, from the packet forwarding device and, when compression-encoding the screen information in part or in whole, transmits an encode result to the packet forwarding device while controlling the bit rate of the compression-encoding so that the bit rate does not exceed a bit rate indicated by the QoS information.

According to an eleventh mode, there is provided the remote mobile communication system wherein at least one of an MBR(Maximum Bit Rate) and a GBR(Guaranteed Bit Rate) is used as the QoS information.

According to a twelfth mode, there is provided the remote mobile communication system wherein ECN(Explicit Congestion Notification) information is acquired from the packet forwarding device and, when compression-encoding the screen information in part or in whole, the bit rate of the encoder unit is controlled based on the ECN information.

According to a thirteenth mode, there is provided the remote mobile communication system, wherein the server device further comprises a control unit that collects device type information from the mobile terminal, obtains an ability of the mobile terminal from the device type information and an ability table, and controls at least one of an encode format, bit rate, and screen resolution of the encoder unit to suit the obtained ability.

According to a fourteenth mode, there is provided the remote mobile communication system, wherein the mobile terminal temporarily stores information, such as content, using a cache memory or a storage device provided in the server device.

According to a fifteenth mode, there is provided the remote mobile communication system, wherein the mobile network is a mobile packet network or a mobile LTE/EPC network.

According to a sixteenth mode, there is provided the server device wherein the encoder unit acquires downlink bearer QoS(Quality of Service) information, which is set by the packet forwarding device, from the packet forwarding device and, when compression-encoding the screen information in part or in whole, transmits an encode result to the packet forwarding device while controlling the bit rate of the compression-encoding so that the bit rate does not exceed a bit rate indicated by the QoS information.

According to a seventeenth mode, there is provided the server device wherein at least one of an MBR(Maximum Bit Rate) and a GBR(Guaranteed Bit Rate) is used as the QoS information.

According to an eighteenth mode, there is provided the server device wherein ECN(Explicit Congestion Notification) information is acquired from the packet forwarding device and, when compression-encoding the screen information in part or in whole, the bit rate of the encoder unit is controlled based on the ECN information.

According to a nineteenth mode, there is provided the server device, wherein the server device further comprises a control unit that collects device type information from the mobile terminal, obtains an ability of the mobile terminal from the device type information and an ability table, and controls at least one of an encode format, bit rate, and screen resolution of the encoder unit to suit the obtained ability.

According to a twentieth mode, there is provided the server device, the server device further comprising a cache memory or a storage device that temporarily stores information, such as content, for a mobile terminal.

According to a twenty-first mode, there is provided the remote mobile communication method, comprising:
by the server device, acquiring downlink bearer QoS(Quality of Service) information, which is set by the packet forwarding device, from the packet forwarding device; and
when compression-encoding the screen information in part or in whole, transmitting an encode result to the packet forwarding device while controlling the bit rate of the compression-encoding so that the bit rate does not exceed a bit rate indicated by the QoS information.

According to a twenty-second mode, there is provided the program, causing the computer to execute:
acquiring downlink bearer QoS(Quality of Service) information, which is set by a packet forwarding device, from the packet forwarding device; and
when compression-encoding the screen information in part or in whole, transmitting an encode result to the packet forwarding device while controlling the bit rate of the compression-encoding so that the bit rate does not exceed a bit rate indicated by the QoS information. The program may be stored in a computer readable storage medium.

The present invention allows the user to introduce a new service by updating application software in the server device installed on a network even when the operator introduces the new service. This eliminates the need for the user to purchase a new mobile terminal each time a new service is introduced.

The present invention uses the device type information on mobile terminals and an ability table to find the ability of a mobile terminal and forwards the mobile terminal screen information from the server device using the codec format, bit rate, and screen resolution that suit the ability. Therefore, the present invention solves the problem that the mobile terminal cannot display an image and the problem that the mobile terminal cannot decode the screen information because of an incompatible bit rate, resolution, or codec format.

The present invention performs the following processing immediately after or during the connection upon detecting a variation in the bandwidth of the mobile packet network or the LTE/EPC network. That is, the system of the present invention collects bearer QoS information to control the maximum bit rate that is used by the server device to compression-encode screen information. The system also checks if the ECN flag is included in the response information from the mobile terminal and, if the ECN flag is included, controls the maximum bit rate that is used for the compression-encoding. By doing so, the system avoids QoE degradation that may be caused by the condition in which the mobile terminal takes long to receive the information and therefore the update of the screen is delayed.

The present invention eliminates the need for a mobile terminal to have a memory or a storage unit when viewing content such as a still image or a moving image. Therefore, even when the mobile network becomes faster and a large volume of content can be viewed, there is no need for the mobile terminal to increase the capacity of the memory or the storage unit.

### First Exemplary Embodiment

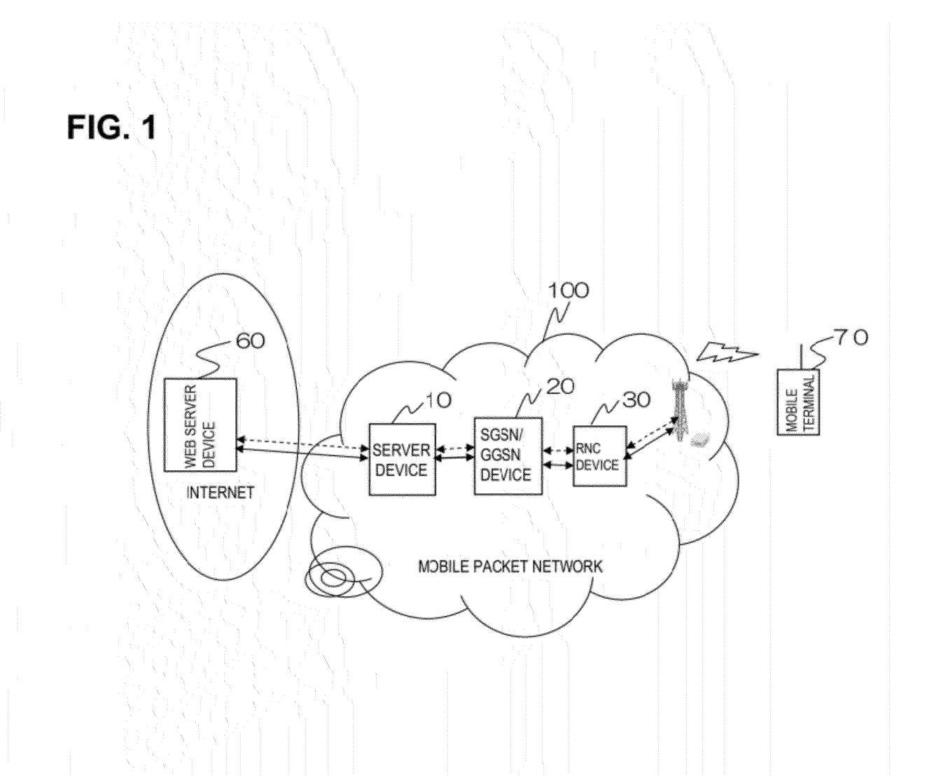

The following describes a remote mobile communication system in a first exemplary embodiment of the present invention with reference to the drawings. FIG. 1 is a block diagram showing a configuration of the remote mobile communication system in the present exemplary embodiment. Referring to FIG. 1, the remote mobile communication system comprises a web server device 60, a server device 10, an SGSN/GGSN(serving/gateway General packet radio service Support Node) device 20, an RNC(Radio Network Controller) device 30, and a mobile terminal 70.

In the present exemplary embodiment, a mobile packet network 100 is used as the network, and the SGSN/GGSN device 20 as the packet forwarding device. Although the figure shows an example of the configuration in which the user browses the web via the mobile terminal 70, services such as content distribution may also be realized based on the similar configuration.

In FIG. 1, the mobile terminal 70 transmits the instruction signal to the server device 10 via the mobile packet network 100 to start application software, installed in the server device 10, for browsing the web. In this case, the instruction signal transmitted from the mobile terminal 70 arrives at the RNC device 30, SGSN/GGSN device 20, and the server device 10 on the mobile packet network 100 in this order.

A known protocol may be used as the protocol for transmitting the instruction signal. In the description below, assume that HTTP(Hypertext Transfer Protocol) is used as an example of the protocol. Other than HTTP, SIP(Session Initiation Protocol) may also be used.

The server device 10 receives the instruction signal, determines that the instruction signal is transmitted to access the web because the URL(Uniform Resource Locator) is included in the instruction signal, accesses the Internet, and then accesses the web server device 60 at the corresponding URL.

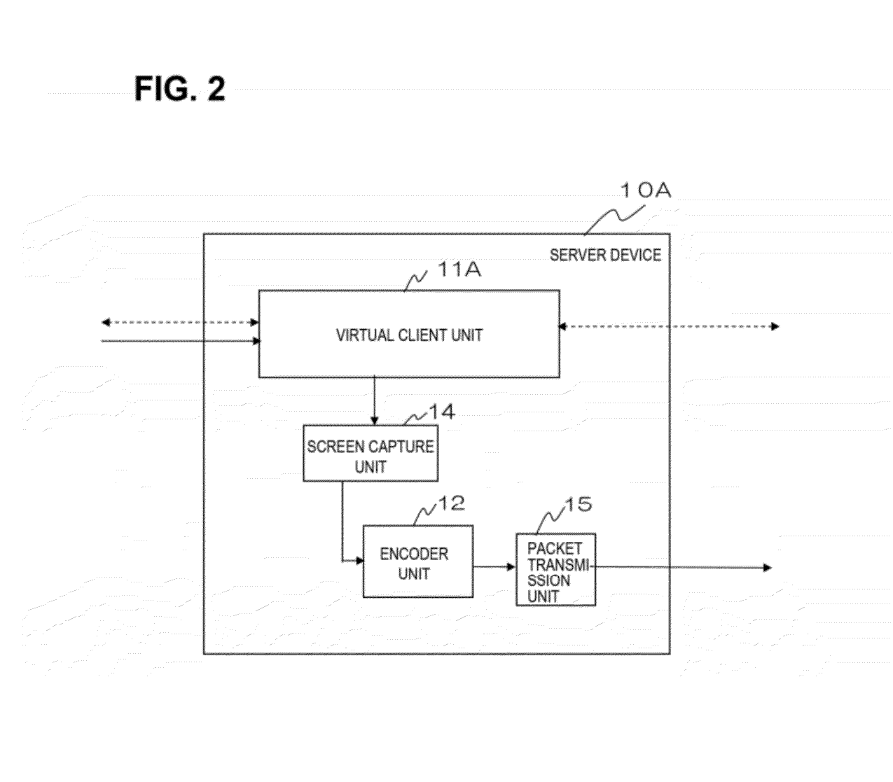

The server device 10 receives HTML information, necessary for browsing, from the web server device 60. After that, as will be described later with reference to FIG. 2, the server device 10 generates screen information for use by the virtual client unit, provided in the server device 10, from the HTML information, compression-encodes the screen information via the encoder, and transmits a compression-encoded bit stream or a file, which stores a compression-encoded bit stream, to the SGSN/GGSN device 20 as a packet.

The SGSN/GGSN device 20 forwards the received packet to the RNC device 30, which transmits the forwarded packet to the mobile terminal 70 via the radio network.

The mobile terminal 70 receives the packet, retrieves the compression-encoded bit stream stored in the packet, enters the bit stream into a decoder corresponding to the encoder for decoding, and displays the browsing screen requested by the instruction signal.

Next, the following describes a server device 10A with reference to the drawings. FIG. 2 is a block diagram showing a configuration of the server device 10A in the remote mobile communication system in the present exemplary embodiment. Referring to FIG. 2, the server device 10A comprises a virtual client unit 11A, a screen capture unit 14, an encoder unit 12, and a packet transmission unit 15.

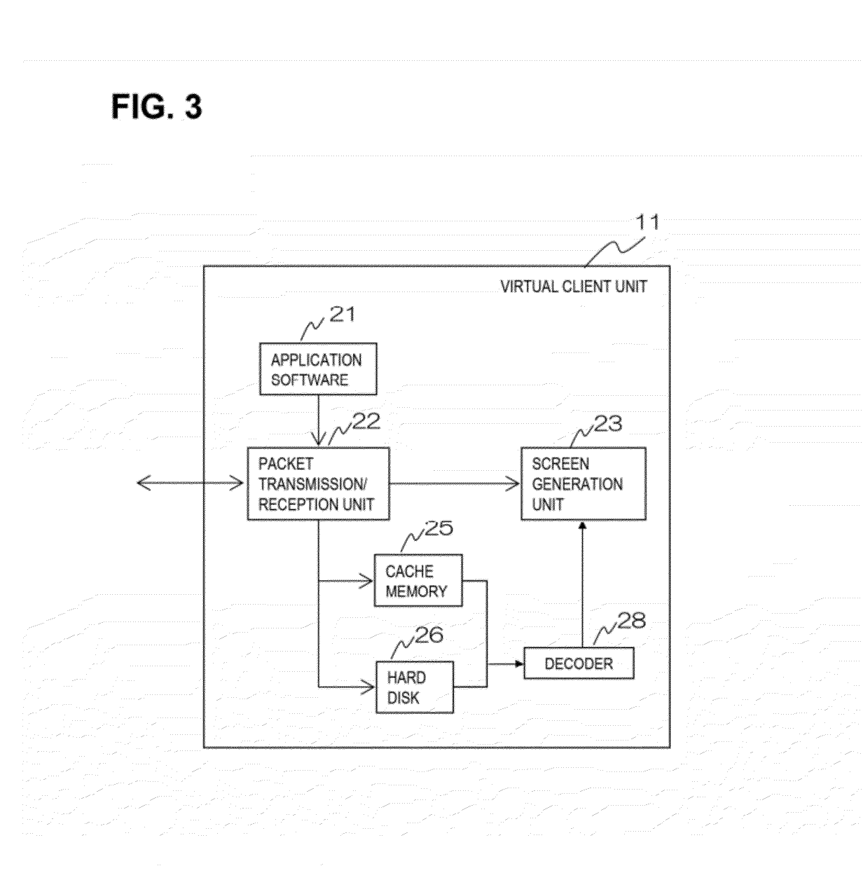

FIG. 3 is a block diagram showing a configuration of the virtual client unit 11 (virtual client unit 11A in FIG. 2) of the server device 10A. Referring to FIG. 3, the virtual client unit 11 comprises application software 21 that supports the new service, a screen generation unit 23, a packet transmission/reception unit 22, a cache memory 25, a hard disk 26 for storing content, and a decoder 28 for decoding an audio, a still image, and a moving image.

The application software 21 may be updated from a device external to the server device 10A.

The virtual client unit 11 receives an instruction signal, which is transmitted from the mobile terminal 70 via the SGSN/GGSN device 20, using the packet transmission/reception unit 22, decodes the received instruction signal to start appropriate application software, and analyzes the URL information included in the instruction signal. If the instruction signal specifies a web browsing request, the virtual client unit 11 generates a connection request signal and, via the packet transmission/reception unit 22, transmits the generated connection request signal to the web server device 60 on the Internet to connect to the web server device 60.

The virtual client unit 11 receives the HTML information, required for web browsing, from the web server device 60, generates image information for performing a screen display, causes the screen generation unit 23 to generate a screen, and outputs the generated screen to the screen capture unit 14.

The screen capture unit 14 captures the screen to find the luminance signal and the color difference signal of the image, and outputs those signals to the encoder unit 12. The image signal may also be represented in other formats such as the YUV format.

The encoder unit 12 uses the predetermined compression-encoding method to compression-encode the captured image information to generate a compression-encoded bit stream and transmits the generated bit stream to the packet transmission unit 15.

The packet transmission unit 15 stores the compression-encoded bit stream in the payload of a packet and transmits the packet to the SGSN/GGSN device 20. The packet transmission unit 15 may also store the compression-encoded bit stream once in a file and then transmits the file as a packet. In this case, TCP/IP(Transmission Control Protocol/Internet Protocol) may be used as the packet protocol.

Although the configuration for browsing the web is shown in FIG. 2, the service for viewing still image content or moving image content may also be implemented based on the same configuration. In this case, when an instruction is received from the mobile terminal 70, the virtual client unit 11 installed in the server device 10A connects, not to the web server device, but to the content server, to read the file or the stream of the content, which the user wants to view, from the content server. After that, the virtual client unit 11 can temporarily store the content in the cache memory 25 or the hard disk 26 provided for storing content, decode the content using the decoder 28 provided for decoding still images or moving images, generate a screen from the decoded image information, and output the generated screen to the screen capture unit 14. This configuration does not require the mobile terminal 70 to store content, eliminating the need for the mobile terminal 70 to have a memory or a storing unit for temporarily storing content.

### Second Exemplary Embodiment

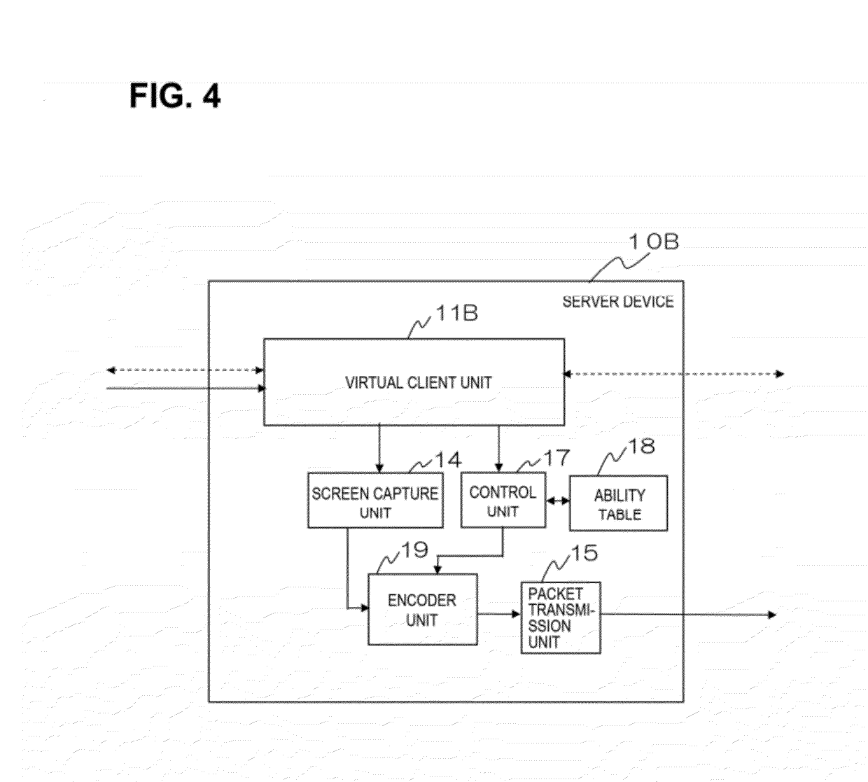

The following describes a server device in a remote mobile communication system in a second exemplary embodiment of the present invention with reference to the drawings. FIG. 4 is a block diagram showing a configuration of a server device 10B in the remote mobile communication system in the present exemplary embodiment. Referring to FIG. 4, the server device 10B comprises a virtual client unit 11B, a screen capture unit 14, an encoder unit 19, a control unit 17, an ability table 18, and a packet transmission unit 15. An element in FIG. 4 with the same reference numeral as that of an element in FIG. 2 performs the operation similar to that of the corresponding element in FIG. 2 and, therefore, the further description of that element will be omitted.

The virtual client unit 11B receives not only instruction information but also the device type information on a mobile terminal 70 from the mobile terminal 70 and outputs the received information to the control unit 17.

The control unit 17 receives device type information on the mobile terminal 70 from the virtual client unit 11B and, based on the received device type information, accesses the ability table 18 to obtain information on the ability of the mobile terminal 70.

The ability table 18 includes the mapping information between the device type information and the ability.

The control unit 17 controls at least one of the parameters—encode format, encode bit rate, and screen resolution—for the encoder unit 19 based on the ability of the mobile terminal 70.

The encoder unit 19, which has multiple types of encode format, receives at least one of the parameters—encode format, encode bit rate, and screen resolution—from the control unit 17 and selects the encode format, sets the bit rate, or sets the screen resolution. After that, the encoder unit 19 compression-encodes the luminance signal and the color difference signal of the image, received from the screen capture unit 14, to generate a compression-encoded bit stream and transmits the generated bit stream to the packet transmission unit 15. Note that other formats, such as the YUV format, may also be used for the image signal.

Although the configuration for browsing the web is shown in FIG. 4, the service for viewing still image content or moving image content may also be implemented based on the same configuration. In this case, when an instruction is received from the mobile terminal 70, the virtual client unit 11B installed in the server device 10B connects, not to the web server device, but to the content server, to read the file or the stream of the content, which the user wants to view, from the content server. After that, the virtual client unit 11B can temporarily store the content in the cache memory 25 or the hard disk 26 provided for storing content, decode the content using the decoder 28 provided for decoding still images or moving images, generate a screen from the decoded image information, and output the generated screen to the screen capture unit 14. This configuration does not require the mobile terminal 70 to store content, eliminating the need for the mobile terminal 70 to have a memory or a storing unit for temporarily storing content.

### Third Exemplary Embodiment

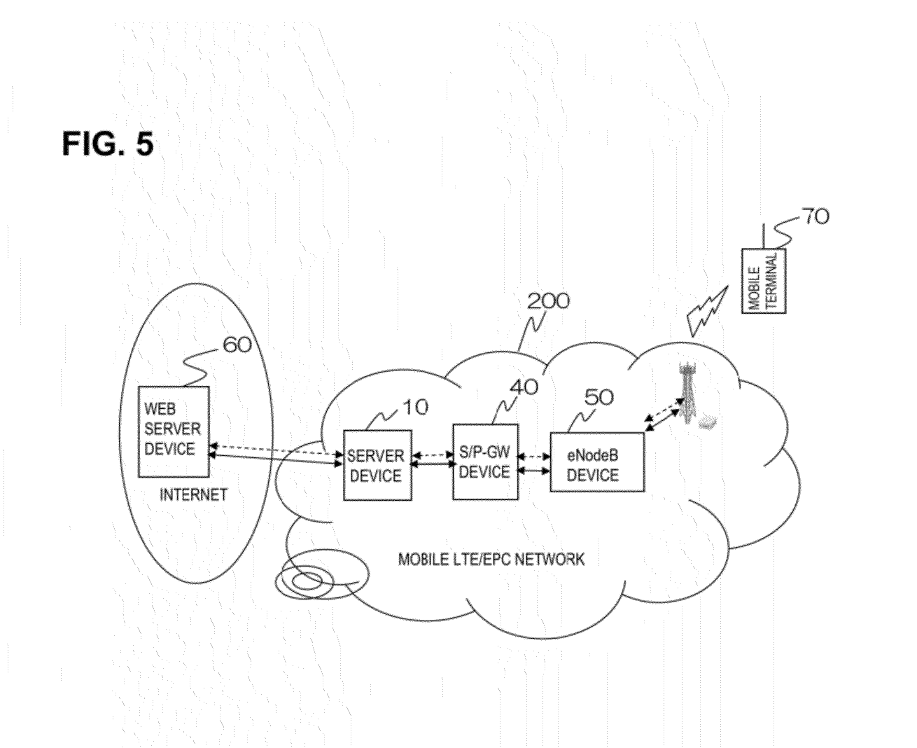

The following describes a remote mobile communication system in a third exemplary embodiment of the present invention with reference to the drawings. FIG. 5 is a block diagram showing a configuration of the remote mobile communication system in the present exemplary embodiment. Referring to FIG. 5, the remote mobile communication system comprises a web server device 60, a server device 10, an S/P-GW device 40, an eNodeB device 50, and a mobile terminal 70. An element in FIG. 5 with the same reference numeral as that of an element in FIG. 1 performs the operation similar to that of the corresponding element in FIG. 1 and, therefore, the further description of that element will be omitted.

The present exemplary embodiment (FIG. 5) differs from the first exemplary embodiment (FIG. 1) in that the mobile terminal 70 is connected to the server device 10 via the eNodeB device 50 and the S/P-GW device 40 over a mobile LTE/EPC network 200. Packets are forwarded much faster in the present exemplary embodiment than in the first exemplary embodiment (FIG. 1).

The eNodeB(enhanced Node B) device 50 uses the LTE technology to realize packet transmission that is faster than the conventional device in the radio segment. Because the IP protocol is used for connection between the S/P-GW device 40 and the server device 10, the server device in FIG. 1 may be used without change even when connected to the S/P-GW device 40.

The S/P-GW device 40 receives the UDP/IP or TCP/IP protocol and a file, which is forwarded via one of those protocols, from the server device 10, converts the protocol to the GTP-U(GPRS Tunneling Protocol-User Plane)/UDP/IP protocol, and outputs the converted file to the eNodeB device 50.

The eNodeB device 50 converts the protocol to the PDCP/RLC(Packet Data Convergence Protocol/Radio Link Control) protocol and transmits the packet and the file to the mobile terminal 70.

As the server device 10 in FIG. 5, not only the server device 10A in FIG. 2 but also the server device 10B in FIG. 4 may be used.

### Fourth Exemplary Embodiment

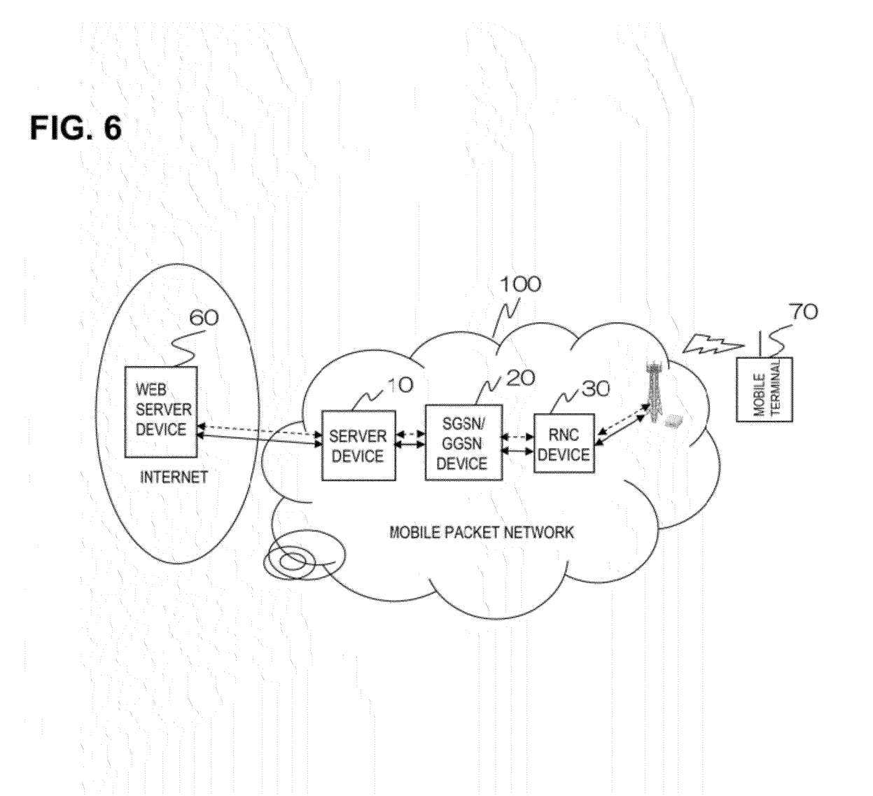

The following describes a remote mobile communication system in a fourth exemplary embodiment of the present invention with reference to the drawings. FIG. 6 is a block diagram showing a configuration of the remote mobile communication system in the present exemplary embodiment. Referring to FIG. 6, the remote mobile communication system comprises a web server device 60, a server device 10, an SGSN/GGSN device 20, an RNC device 30, and a mobile terminal 70.

In the present exemplary embodiment, a mobile packet network 100 is used as the network, and the SGSN/GGSN device 20 as the packet forwarding device. Although the figure shows an example of the configuration in which the user uses the web browsing service via the mobile terminal 70, services such as content distribution may also be realized based on the similar configuration.

In FIG. 6, the mobile terminal 70 transmits the instruction signal to the server device 10 via the mobile packet network 100 to start application software, installed in the server device 10, for browsing the web. At this time, the instruction signal transmitted from the mobile terminal 70 arrives at the RNC device 30 and the SGSN/GGSN device 20 on the mobile packet network 100 in this order and the server device 10 receives the instruction signal.

A known protocol may be used as the protocol for transmitting the instruction signal. In the description below, assume that HTTP is used as an example of the protocol. Other than HTTP, SIP(Session Initiation Protocol) may also be used.

The server device 10 receives the instruction signal, determines that the instruction signal is transmitted to access the web because the URL is included in the instruction signal, accesses the Internet, and then accesses the web server device 60 at the corresponding URL.

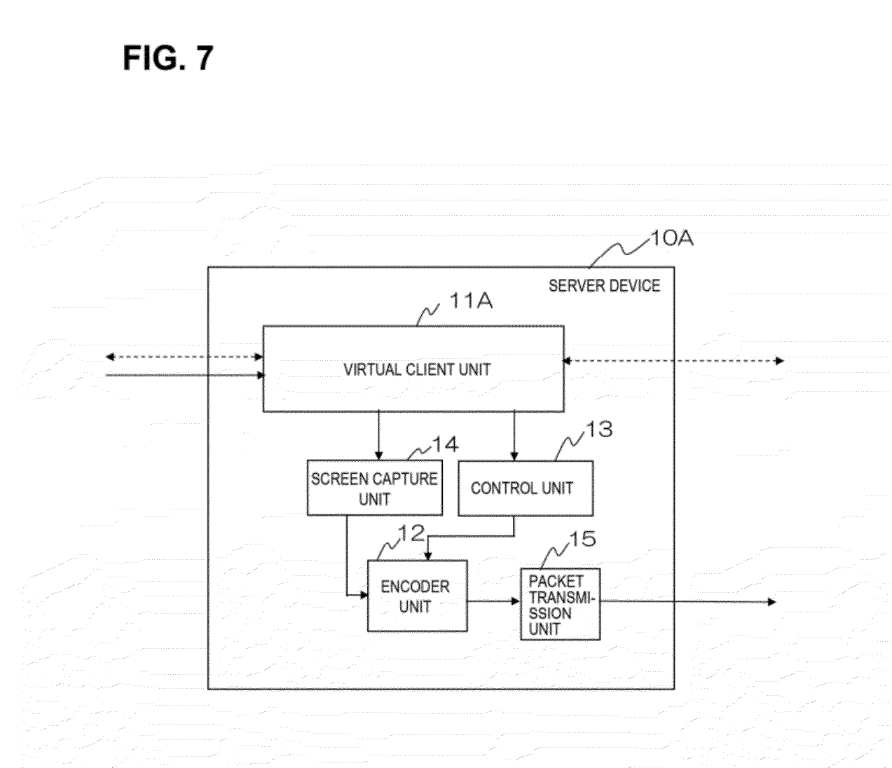

The server device 10 receives HTML information, necessary for browsing, from the web server device 60. After that, as will be described later with reference to FIG. 7, the server device 10 generates screen information for use by the virtual client unit, provided in the server device 10, from the HTML information, compression-encodes the screen information via the encoder to generate a compression-encoded bit stream or a file, which stores a compression-encoded bit stream, and transmits it to the SGSN/GGSN device 20 as a packet.

In the description below, assume that TCP/IP is used as the protocol for transmitting a packet from the server device 10 to the SGSN/GGSN device 20. Other than TCP/IP, the UDP/IP protocol may also be used.

The SGSN/GGSN device 20 forwards the packet, received via TCP/IP, to the RNC device 30 by establishing a tunnel using the GTP-U protocol, and the RNC device 30 transmits the forwarded packet to the mobile terminal 70 via the radio network.

The mobile terminal 70 receives the packet via the TCP/IP protocol, retrieves the compression-encoded bit stream stored in the packet, decodes the bit stream using a decoder corresponding to the encoder, and displays the browsing screen requested by the instruction signal.

Next, the following describes a server device 10A with reference to the drawings. FIG. 7 is a block diagram showing a configuration of the server device 10A in the remote mobile communication system in the present exemplary embodiment. Referring to FIG. 7, the server device 10A comprises a virtual client unit 11A, a screen capture unit 14, an encoder unit 12, a control unit 13, a packet transmission unit 15.

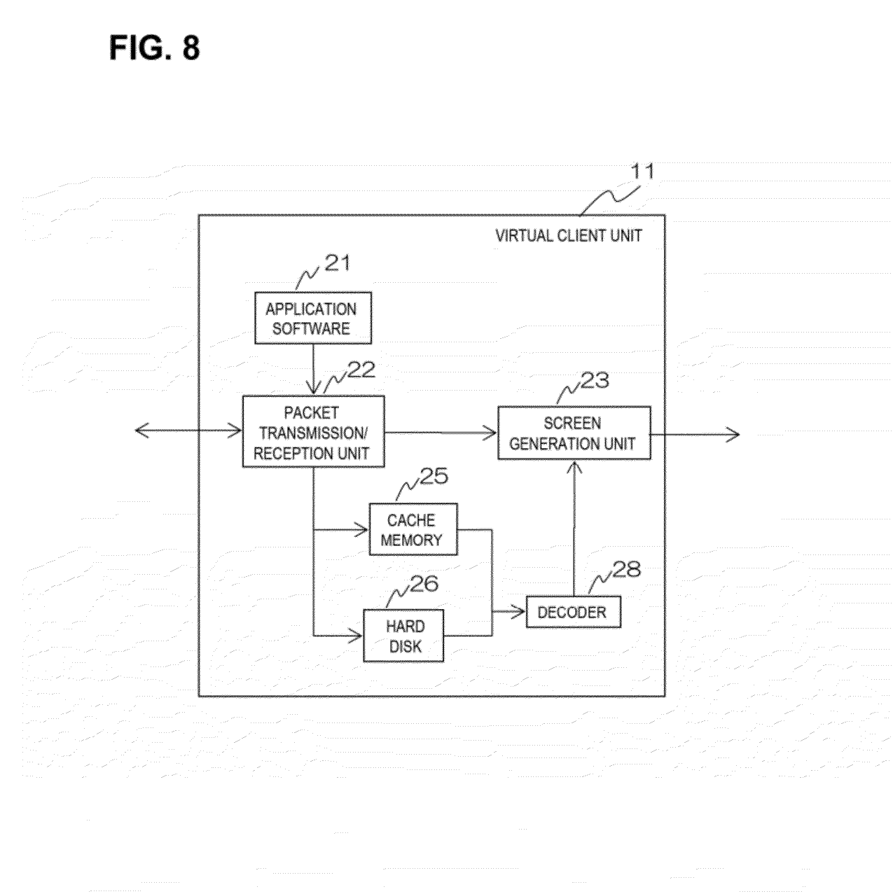

FIG. 8 is a block diagram showing a configuration of the virtual client unit 11 (virtual client unit 11A in FIG. 7) of the server device 10A. Referring to FIG. 8, the virtual client unit 11 comprises application software 21 that supports the new service, a screen generation unit 23, a packet transmission/reception unit 22, a cache memory 25, a hard disk 26 for storing content, and a decoder 28 for decoding an audio, a still image, and a moving image.

The application software 21 may be updated from a device external to the server device 10A.

The virtual client unit 11 receives an instruction signal, which is transmitted from the mobile terminal 70 via the SGSN/GGSN device 20, using the packet transmission/reception unit 22, decodes the received instruction signal to start appropriate application software, and analyzes the URL information included in the instruction signal. If the instruction signal specifies a web browsing request, the virtual client unit 11 generates a connection request signal and, via the packet transmission/reception unit 22, transmits the generated connection request signal to the web server device 60 on the Internet to connect to the web server device 60.

The virtual client unit 11 receives the HTML information, required for web browsing, from the web server device 60, generates image information for performing a screen display, causes the screen generation unit 23 to generate a screen, and outputs the generated screen to the screen capture unit 14.

The screen capture unit 14 captures the screen to find the luminance signal and the color difference signal of the image, and outputs those signals to the encoder unit 12. The image signal may also be represented in other formats such as the YUV format.

The control unit 13 performs at least one of the following two operations, (a) and (b), immediately after or during the connection to the mobile terminal 70.

### (a) Collection and Control of QoS Information

When a call is connected, the SGSN/GGSN device 20 first sets the QoS of the bearer in the RNC device 30. The virtual client unit 11 collects the QoS information that is set for the bearer. As the QoS information, the virtual client unit 11 receives at least one of the MBR(Maximum Bit Rate) and the GBR(Guaranteed Bit Rate) and controls the bit rate, which is used by the encoder unit 12 for compression-encoding, so that the bit rate does not exceed at least one of the two bit rates given above. Assume that the present exemplary embodiment is configured to receive GBR and controls the encoding based on GBR. That is, the control unit 13 controls the compression-encoding of the encoder unit 12 so that the maximum bit rate of the encoder unit 12 does not exceed GBR.

### (b) Collection and Control of ECN Information

When congestion is detected in the mobile packet network, the mobile terminal 70 or the RNC device 30 includes the ECN(Explicit Congestion Notification) flag in a TCP/IP response packet from the mobile terminal 70 and then transmits the packet to the SGSN/GGSN device 20. The control unit 13 checks the response packet received from the packet forwarding device and, if the ECN flag is included, instructs the encoder unit 12 to reduce the maximum bit rate at compression-encoding time to control the encoding processing. After that, if a response packet from the mobile terminal 70, received from the SGSN/GGSN device 20, does not include the ECN flag, the control unit 13 instructs the encoder unit 12 to return the maximum bit rate at compression-encoding time to the original numeric value.

The screen capture unit 14 captures the screen, finds the luminance signal and the color difference signal of the image, and outputs those signals to the encoder unit 12. The image signal may also be represented in other formats such as the YUV format.

The encoder unit 12 receives the instruction, which indicates the maximum bit rate for compression-encoding, from the control unit 13, uses the predetermined compression-encoding method to compression-encode the captured image information so that the bit rate does not exceed the maximum bit rate, generates a compression-encoded bit stream, and transmits the bit stream to the packet transmission unit 15.

The packet transmission unit 15 stores the compression-encoded bit stream in the payload of a packet and, using the TCP/IP protocol, transmits the packet to the SGSN/GGSN device 20. The packet transmission unit 15 may also store the compression-encoded bit stream once in a file and then transmits the file as a packet. In this case, TCP/IP may be used as the packet protocol.

Although the configuration for browsing the web is shown in FIG. 7, the service for viewing still image content or moving image content may also be implemented based on the same configuration. In this case, when an instruction is received from the mobile terminal 70, the virtual client unit 11 installed in the server device 10A connects, not to the web server device, but to the content server, to read the file or the stream of the content, which the user wants to view, from the content server. After that, the virtual client unit 11 can temporarily store the content in the cache memory 25 or the hard disk 26 provided for storing content, decode the content using the decoder 28 provided for decoding still images or moving images, generate a screen from the decoded image information, and output the generated screen to the screen capture unit 14. This configuration does not require the mobile terminal 70 to store content, eliminating the need for the mobile terminal 70 to have a memory or a storing unit for temporarily storing content.

Although TCP/IP is used as the protocol for transmission from the packet transmission unit, other protocols may also be used as described below. For example, when UDP/IP is used, RTCP(Real time protocol Control Protocol) or RTCP-APP(RTCP Application defined) may be used instead of TCP/IP to transmit a response from the mobile terminal 70. In this case, the virtual client unit 11 receives the response from the SGSN/GGSN device 20 using RTCP or RTCP-APP and the control unit 13 checks the response for the ECN flag. On the other hand, when SIP/SDP(Session Initiation Protocol/Session Description Protocol) is used, the ECN flag is included in one of the SIP response message or the SDP response message received from the mobile terminal 70. Therefore, the control unit 13 checks this message for the ECN flag.

### Fifth Exemplary Embodiment

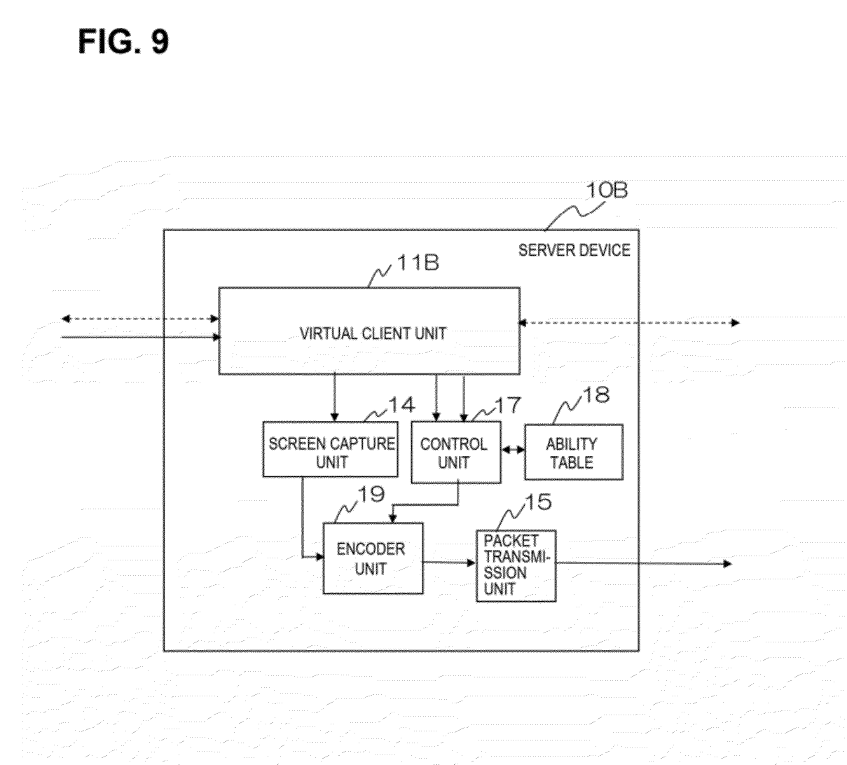

The following describes a server device in a remote mobile communication system in a fifth exemplary embodiment of the present invention with reference to the drawings. FIG. 9 is a block diagram showing a configuration of a server device 10B in the remote mobile communication system in the present exemplary embodiment. Referring to FIG. 9, the server device 10B comprises a virtual client unit 11B, a screen capture unit 14, an encoder unit 19, a control unit 17, an ability table 18, and a packet transmission unit 15. An element in FIG. 9 with the same reference numeral as that of an element in FIG. 7 performs the operation similar to that of the corresponding element in FIG. 7 and, therefore, the further description of that element will be omitted.

In addition to the operation shown in FIG. 7, the virtual client unit 11B receives instruction information, bearer QoS information, and ECN information, as well as the device type information on the mobile terminal 70, from the SGSN/GGSN device 20 and outputs the received information to the control unit 17. The control unit 17 receives the device type information on the mobile terminal 70 and the bearer QoS information or the ECN flag from the virtual client unit 11B and access the ability table 18 based on the device type information to find the ability of the mobile terminal 70.

The ability table 18 includes the mapping information between the device type information and the ability.

The control unit 17 controls at least one of the parameters—encode format, encode bit rate, and screen resolution—for the encoder unit 19 based on the ability of the mobile terminal 70.

In addition, as described with reference to FIG. 7, the control unit 17 performs at least one of the two operations, (a) collection and control of QoS information and (b) collection and control of ECN information, immediately after or during the connection to the mobile terminal 70 to set the maximum bit rate that is used by the encoder unit 19 for compression-encoding.

The encoder unit 19, which has multiple types of encode format, receives at least one of the parameters—encode format, encode bit rate, and screen resolution—from the control unit 17 and selects the encode format, sets the bit rate, or sets the screen resolution. In addition, the encoder unit 19 receives the maximum bit rate instruction from the control unit 17 and sets this numeric value as the maximum bit rate for compression-encoding. After that, the encoder unit 19 compression-encodes the luminance signal and the color difference signal of the image, received from the screen capture unit 14, to generate a compression-encoded bit stream and transmits the generated bit stream to the packet transmission unit 15. Note that other formats, such as the YUV format, may also be used for the image signal.

Although the configuration for browsing the web is shown in FIG. 9, the service for viewing still image content or moving image content may also be implemented based on the same configuration. In this case, when an instruction is received from the mobile terminal 70, the virtual client unit 11B installed in the server device 10B connects, not to the web server device, but to the content server, to read the file or the stream of the content, which the user wants to view, from the content server. After that, the virtual client unit 11B can temporarily store the content in the cache memory 25 or the hard disk 26 provided for storing content, decode the content using the decoder 28 provided for decoding still images or moving images, generate a screen from the decoded image information, and output the generated screen to the screen capture unit 14. This configuration does not require the mobile terminal 70 to store content, eliminating the need for the mobile terminal 70 to have a memory or a storing unit for temporarily storing content.

Although TCP/IP is used as the protocol for transmission from the packet transmission unit, other protocols may also be used as described below. For example, when UDP/IP is used, RTCP or RTCP-APP may be used instead of TCP/IP to transmit a response from the mobile terminal 70. In this case, the virtual client unit 11 receives a response from the SGSN/GGSN device 20 using RTCP or RTCP-APP and the control unit 17 checks the response for the ECN flag. On the other hand, when SIP/SDP is used, the ECN flag is included in one of the SIP response message or the SDP response message received from the mobile terminal 70. Therefore, the control unit 17 checks this message for the ECN flag.

### Sixth Exemplary Embodiment

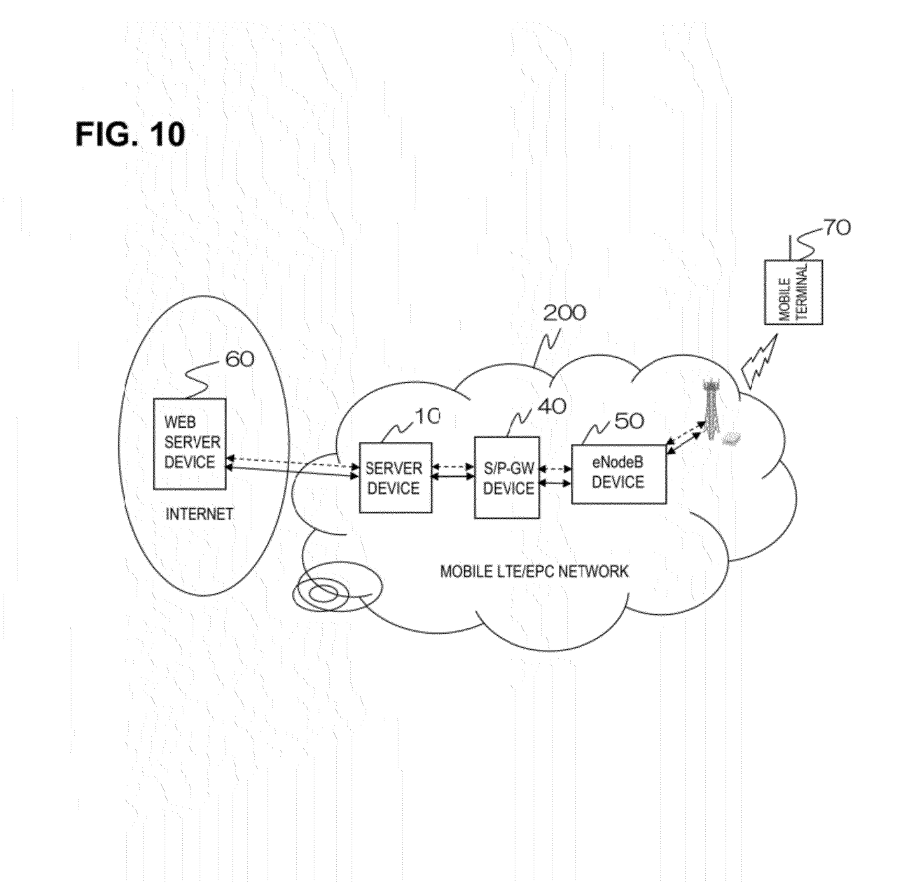

The following describes a remote mobile communication system in a sixth exemplary embodiment of the present invention with reference to the drawings. FIG. 10 is a block diagram showing a configuration of the remote mobile communication system in the present exemplary embodiment. Referring to FIG. 10, the remote mobile communication system comprises a web server device 60, a server device 10, an S/P-GW device 40, an eNodeB device 50, and a mobile terminal 70. An element in FIG. 10 with the same reference numeral as that of an element in FIG. 6 performs the operation similar to that of the corresponding element in FIG. 6 and, therefore, the further description of that element will be omitted.

The present exemplary embodiment (FIG. 10) differs from the fourth exemplary embodiment (FIG. 6) in that the mobile terminal 70 is connected to the server device 10 via the eNodeB device 50 and the S/P-GW device 40 over a mobile LTE/EPC network 200. Packets are forwarded much faster in the present exemplary embodiment than in the fourth exemplary embodiment (FIG. 6).

The eNodeB (enhanced Node B) device 50 uses the LTE technology to realize packet transmission that is faster than the conventional device in the radio segment. Because the IP protocol is used for connection between the S/P-GW device 40 and the server device 10, the server device in FIG. 6 may be used without change even when connected to the S/P-GW device 40.

The S/P-GW device 40 receives the UDP/IP or TCP/IP protocol and a file, which is forwarded via one of those protocols, from the server device 10, converts the protocol to the GTP-U(GPRS Tunneling Protocol-User Plane)/UDP/IP protocol, and outputs the converted file to the eNodeB device 50.

The eNodeB device 50 converts the protocol to the PDCP/RLC protocol and transmits the packet and the file to the mobile terminal 70.

As the server device 10 in FIG. 10, not only the server device 10A in FIG. 7 but also the server device 10B in FIG. 9 may be used. As the protocol for transmission from the server device, not only TCP/IP but also UDP/IP may be used. To transmit a response signal from the mobile terminal 70, not only TCP/IP but also SIP and SDP may be used.

Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept.

### EXPLANATION OF SYMBOLS

10,10A,10B server device

11,11A,11B virtual client unit

12,19 encoder unit

13,17 control unit

14 screen capture unit

15 packet transmission unit

18 ability table

20 SGSN/GGSN device

21 application software

22 packet transmission/reception unit

23 screen generation unit

25 cache memory

26 hard disk

28 decoder

30 RNC device

40 S/P-GW device

50 eNodeB device

60 web server device

70 mobile terminal

100 mobile packet network

200 mobile LTE/EPC network

1. A remote mobile communication system, comprising:
a server device that comprises:
a virtual client unit that receives instruction information from a mobile terminal via a mobile network and, based on the instruction information, generates screen information for causing an application to perform a screen display; and an encoder unit that compression-encodes the screen information, in part or in whole, and transmits the compression-encoded screen information to the mobile network; and
a mobile terminal that receives the compression-encoded screen information via the mobile network and decompresses the screen information for display.

2. The remote mobile communication system according to claim 1, wherein the server device further comprises a control unit that collects device type information from the mobile terminal, obtains an ability of the mobile terminal from the device type information and an ability table, and controls at least one of an encode format, bit rate, and screen resolution of the encoder unit to suit the obtained ability.

3. The remote mobile communication system according to claim 1, wherein the mobile terminal temporarily stores information, such as content, using a cache memory or a storage device provided in the server device.

4. The remote mobile communication system according to claim 1, wherein the mobile network is a mobile packet network or a mobile Long Term Evolution/Evolved Packet Core (LTE/EPC) network.

5. A server device comprising:
a virtual client unit that receives instruction information from a mobile terminal via a mobile network and, based on the instruction information, generates screen information for causing an application to perform a screen display; and
an encoder unit that compression-encodes the screen information, in part or in whole, and transmits the compression-encoded screen information to the mobile network.

6. The server device according to claim 5, further comprising a control unit that collects device type information from a mobile terminal, obtains an ability of the mobile terminal from the device type information and an ability table, and controls at least one of an encode format, bit rate, and screen resolution of the encoder unit to suit the obtained ability.

7. The server device according to claim 5, further comprising a cache memory or a storage device that temporarily stores information such as content.

8. A remote mobile communication method comprising:
by a server device, receiving instruction information from a mobile terminal via a mobile network and, based on the instruction information, generating screen information for causing an application to perform a screen display; and compression-encoding the screen information, in part or in whole, and transmitting the compression-encoded screen information to the mobile network.

9. (canceled)

10. The remote mobile communication system according to claim 1, wherein the encoder unit acquires downlink bearer QoS(Quality of Service) information, which is set by the packet forwarding device, from a packet forwarding device and, when compression-encoding the screen information in part or in whole, transmits an encode result to the packet forwarding device while controlling the bit rate of the compression-encoding so that the bit rate does not exceed a bit rate indicated by the QoS information.

11. The remote mobile communication system according to claim 10, wherein at least one of an MBR(Maximum Bit Rate) and a GBR(Guaranteed Bit Rate) is used as the QoS information.

12. The remote mobile communication system according to claim 10, wherein ECN(Explicit Congestion Notification) information is acquired from the packet forwarding device and, when compression-encoding the screen information in part or in whole, the bit rate of the encoder unit is controlled based on the ECN information.

13. The remote mobile communication system according to claim 10, wherein the server device further comprises a control unit that collects device type information from the mobile terminal, obtains an ability of the mobile terminal from the device type information and an ability table, and controls at least one of an encode format, bit rate, and screen resolution of the encoder unit to suit the obtained ability.

14. The remote mobile communication system according to claim 10, wherein the mobile terminal temporarily stores information, such as content, using a cache memory or a storage device provided in the server device.

15. The remote mobile communication system according to claim 10, wherein the mobile network is a mobile packet network or a mobile LTE/EPC network.

16. The server device according to claim 5, wherein
the encoder unit acquires downlink bearer QoS(Quality of Service) information, which is set by the packet forwarding device, from the packet forwarding device and, when compression-encoding the screen information in part or in whole, transmits an encode result to the packet forwarding device while controlling the bit rate of the compression-encoding so that the bit rate does not exceed a bit rate indicated by the QoS information.

17. The server device according to claim 16, wherein at least one of an MBR(Maximum Bit Rate) and a GBR(Guaranteed Bit Rate) is used as the QoS information.

18. The server device according to claim 16, wherein ECN(Explicit Congestion Notification) information is acquired from the packet forwarding device and, when compression-encoding the screen information in part or in whole, the bit rate of the encoder unit is controlled based on the ECN information.

19. The server device according to claim 16, wherein the server device further comprises a control unit that collects device type information from the mobile terminal, obtains an ability of the mobile terminal from the device type information and an ability table, and controls at least one of an encode format, bit rate, and screen resolution of the encoder unit to suit the obtained ability.

20. The server device according to claim 16, further comprising a cache memory or a storage device that temporarily stores information, such as content, for a mobile terminal.

21. The remote mobile communication method according to claim 8, comprising:
by the server device, acquiring downlink bearer QoS(Quality of Service) information, which is set by a packet forwarding device, from the packet forwarding device; and
when compression-encoding the screen information in part or in whole, transmitting an encode result to the packet forwarding device while controlling the bit rate of the compression-encoding so that the bit rate does not exceed a bit rate indicated by the QoS information.

22. (canceled)
